(19) United States
(12) Patent Application Publication
(10) Pub. No.: US 2023/0393446 A1
(43) Pub. Date: Dec. 7, 2023

(54) High-Power Fully-Integrated Frequency Comb Generation Using Multimode Gain Chips

(71) Applicant: The Trustees of Columbia University in the City of New York, New York, NY (US)

(72) Inventors: Andres Gil-Molina, New York, NY (US); Yair Antman, New York, NY (US); Ohad Westreich, New York, NY (US); Xingchen Ji, New York, NY (US); Min Chul Shin, New York, NY (US); Gaurang R Bhatt, New York, NY (US); Bok Young Kim, New York, NY (US); Yoshitomo Okawachi, River Edge, NJ (US); Alexander L Gaeta, New York, NY (US); Michal Lipson, New York, NY (US)

(21) Appl. No.: 18/309,600

(22) Filed: Apr. 28, 2023

Related U.S. Application Data
(60) Provisional application No. 63/337,257, filed on May 2, 2022.

(51) Int. Cl. G02F 1/35; G02F 1/39

(52) U.S. Cl. CPC G02F 1/3511; G02F 2203/56; G02F 1/39

(57) ABSTRACT

Systems, methods, devices, and apparatuses generate a fully integrated broadband high power frequency combs, based on a multimode gain chip. Embodiments can generate a frequency comb spanning over ˜150 nm and include self-injection locking of a multimode chip-based gain, which can allow access to high pump power while maintaining single mode operation. The integrated frequency comb systems and methods can comprise a multimode gain chip, a ring resonator in optical communication with a waveguide and, and an integrated heater in thermal communication with the ring resonator. Embodiments can be configured to receive multimode gain input and effect a single-mode ring feedback to determine a target mode. A temperature of the ring resonator can be optionally adjusted to modulate the ring feedback, and the ring feedback can be applied to the multimode gain input to generate an output frequency comb that includes the target mode.

### CROSS-REFERENCE TO RELATED APPLICATIONS

The present application claims priority to and the benefit of U.S. patent application no. 63/337,257, “High-Power Fully-Integrated Frequency Comb Generation By Using Multimode Gain Chips” (filed May 2, 2022). All foregoing applications are incorporated herein by reference in their entireties for any and all purposes.

### GOVERNMENT RIGHTS

This invention was made with government support under award HR0011-19-2-0014 awarded by the Department of Defense/Defense Advanced Research Projects Agency (DARPA). The government has certain rights in the invention.

### TECHNICAL FIELD

The invention relates to optical apparatuses and more particularly to frequency comb generation, and more particularly to broadband, high power frequency comb generation.

### BACKGROUND

Frequency combs are critically important in a wide range of applications, such as telecommunications technologies and high precision metrology. However, telecommunications usually require minimum power thresholds for frequency combs to become relevant in information error correction and other energy costly processes, and chip-based frequency combs suffer from weak power outputs due to miniaturization. For chip-based frequency combs to have meaningful applications in telecommunications, the power output of the comb should be enough for other signal-processing processes, such as wavelength-division multiplexing and error correction, both of which require minimum power thresholds to be effective.

In recent years, with the rapid development of nanofabrication techniques, low-loss optical micro-cavities have become a widely used tool to generate on-chip frequency combs Specifically, High-Q ring resonators have been shown to exhibit self-oscillations when pumped by a laser, owing to parametric gain induced by Kerr nonlinearity. However, reaching full integration would require that both the ring resonator and the pump source are chip-based and scalable.

Accordingly, realization of frequency combs in a chip-scale integrated platform is especially desired, to utilize the unique properties of frequency combs at large scale, low power consumption and low cost. The generation of fully integrated chip-scale frequency comb sources would offer potential advantages in various applications including telecommunications, spectroscopy and time-keeping, but many of these applications require coherent comb sources with high optical power. Successful implementation of a frequency comb source in wavelength-division multiplexed links requires the usable lines to exceed a certain power threshold in order to meet the link budget. Each line must also have sufficiently low relative intensity noise to allow for low bit-error-rate communications.

While it has been shown that Kerr combs operating in the normal group-velocity dispersion (GVD) regime have the potential to meet both goals, unlike the case of anomalous GVD, where the spectral shape is constrained to that of a sech2 profile corresponding to a dissipative Kerr soliton, normal GVD operating results in a solution that consists of interlocking of switching wave allowing for higher conversion efficiencies and a flatter spectrum. Accordingly, improvements in the field are needed to address the above challenges.

### SUMMARY

The present disclosure relates to fully integrated broadband high power frequency combs, based on a multimode gain chip. Embodiments can include systems, methods, devices, and apparatuses to generate a Kerr frequency comb, e.g., in a SiN ring, with the frequency comb spanning over ˜150 nm using about 23 mW of pump power. Aspects of the present disclosure include self-injection locking of a multimode chip-based gain, which can allow access to high pump power while maintaining single mode operation. The examples discussed herein can utilize a multimode gain chip to increase input powers for frequency comb generation, and implement a self-locking injection technique, which takes optical feedback from the ring to force mode coherence and convert the multimode signal into a single-mode channel.

Embodiments can utilize the single-mode signal to pump the ring resonator to produce Kerr frequency combs in the normal Group Velocity Dispersion (GVD) regime, and thereby produce flatter comb spectra. In various examples, embodiments can produces 27 lines at powers greater than 100 uW, and 41 lines at greater than 50 uW powers, with only a 3A laser pump current.

Various integrated frequency comb systems and methods, as discussed herein, can comprise a multimode gain chip configured to provide a multimode gain input, a device coupled to the multimode gain chip, and a ring resonator in optical communication with the waveguide and in thermal communication with the integrated heater. In embodiments, the device can comprise a waveguide and an integrated heater. The device can be further configured to receive the multimode gain input. The ring resonator can be configured to effect a single-mode ring feedback to determine a target mode, and the integrated heater can adjust a temperature of the ring resonator so as to modulate the ring feedback. In embodiments, the ring resonator can apply the ring feedback to the multimode gain input to generate an output frequency comb that includes the target mode.

Embodiments of the present invention can be applied to various products, services, and applications including but not limited to: metrology, GPS and tracking technologies, spectroscopy, telecommunications, CMOS-compatible circuit design/manufacturing, and photonic integrated circuits.

The scope of the invention also includes a system including a processor that executes stored instructions for executing the steps of the method. The above and other characteristic features of the invention will be apparent from the following detailed description of the invention.

### BRIEF DESCRIPTION OF THE DRAWINGS

The present application is further understood when read in conjunction with the appended drawings. The file of this patent or application contains at least one drawing/photograph executed in color. Copies of this patent or patent application publication with color drawing(s)/photograph(s) will be provided by the Office upon request and payment of the necessary fee. In the drawings:

FIG. 1A illustrates a schematic of the integrated broadband high power frequency comb source in accordance with aspects of the present disclosure.

FIG. 1B illustrates optical images of the spatially and spectrally multimode gain chip and the fabricated silicon nitride device in accordance with aspects of the present disclosure.

FIG. 2 illustrates an optical spectrum of the generated frequency comb in accordance with aspects of the present disclosure. The optical power of the pump at the output waveguide corresponds to ˜23 mW and the comb spans over ˜150 nm.

FIG. 3 illustrates an example of a series of modes generated by multimode gain chips in accordance with aspects of the present disclosure.

FIG. 4 illustrates a multimode gain chip and device in accordance with aspects of the present disclosure.

FIG. 5 illustrates a multimode gain chip coupled to a silicon nitride device, in accordance with aspects of the present disclosure.

FIG. 6A illustrates spectral data for a frequency comb generated with no ring feedback.

FIG. 6B illustrates spectral data for a frequency comb generated with ring feedback and modal collapse.

FIG. 7A illustrates a linewidth measurement for a locked laser configuration in accordance with aspects of the present disclosure.

FIG. 7B illustrates an example of a delayed self-heterodyne setup, in accordance with aspects of the present disclosure.

FIG. 8A illustrates an example of course wavelength tuning, in accordance with aspects of the present disclosure.

FIG. 8B illustrates an example of fine wavelength tuning, in accordance with aspects of the present disclosure.

FIG. 9 illustrates an example of high-power and broadband comb generation in accordance with aspects of the present disclosure.

FIG. 10 illustrates another example of high-power and broadband comb generation in accordance with aspects of the present disclosure.

FIG. 11 illustrates optical power efficiency for multi-mode and single-mode, in accordance with aspects of the present disclosure.

FIG. 12 illustrates optical and electrical power, in accordance with aspects of the present disclosure.

FIG. 13A illustrates a schematic and experimental setup, in accordance with aspects of the present disclosure. FN refers to frequency noise, and OSA refers to an optical spectrum analyzer.

FIG. 13B illustrates a microscope image of the fabricated device, in accordance with aspects of the present disclosure.

FIG. 14 illustrates an optical spectrum of a generated comb, in accordance with aspects of the present disclosure. The orange dashed line denotes the threshold of 100 μW power.

FIG. 15A illustrates a frequency noise measurement of one of the comb lines around 1571 nm. The gray dashed line denotes the upper bound of the intrinsic linewidth of 200 kHz.

FIG. 15B illustrates an eye diagram of the intensity-modulated comb line at 12.5 Gb/s, in accordance with aspects of the present disclosure.

FIGS. 16A-B illustrate an integrated high-power microcomb source in accordance with aspects of the present disclosure.

FIG. 16A illustrates schematic of a hybrid integration approach with an artistic view of a diffractive element to spectrally separate the comb lines, in accordance with aspects of the present disclosure. Spectral components are illustrated in the visible spectrum instead of the near-Infrared.

FIG. 16B illustrates a photograph of the implemented device: III-V multimode gain laser edge-coupled to the Si₃N₄ chip, in accordance with aspects of the present disclosure. Wirebonds are used to electrically pump the gain chip and control the phase tuning of the bus waveguide and ring resonator for resonance detuning. Inset: optical image (top view) of the fabricated Si₃N₄ device.

FIGS. 17A-C illustrate high-power frequency comb generation.

FIG. 17A provides a comb separated by a single ring FSR (198 GHz) with on-chip power of 160 mW, obtained with 4.2 W electrical pump power, 0 mW, and 0 mW electrical power applied to the ring and bus heaters, in accordance with aspects of the present disclosure.

FIG. 17B provides a comb separated by twice the ring FSR (396 GHz) with on-chip power of 106 mW, obtained with electrical pump power of 2.6 W and 175 mW and 40 mW applied to the ring and bus heaters, in accordance with aspects of the present disclosure.

FIG. 17C illustrates a comb separated by four times the ring FSR (792 GHz) with on-chip power of 73 mW, obtained with electrical pump power of 3.7 W and 180 mW and 45 mW applied to the ring and bus heaters, in accordance with aspects of the present disclosure. The power values extracted from the spectra do not include the spectral region that is obscured by spontaneous emission, so they are an underestimate.

FIGS. 18A and 18B illustrate narrow-linewidth frequency-comb lines, in accordance with aspects of the present disclosure. FIG. 18A provides measured single-sideband power-spectral density of the frequency noise of one of the comb lines at 1570.5 nm. The upperbound for the intrinsic linewidth of 200 kHz is denoted by highlighting the flat area between 106 and 107 Hz. The inset illustrates a lineshape of the measured RF beatnote and a Voigt profile fitted curve with intrisic linewidth of 200 kHz (Lorentizian contribution) and technical noise of 650 kHz (Gaussian contribution). FIG. 18B provides an eye diagram at 12.5 Gb/s using one of the comb lines at 1570.3 nm and a commercial electro-optic modulator, in accordance with aspects of the present disclosure.

FIGS. 19A-19B provide a comparison between unlocked and mode-locked combs. Unlocked (FIGS. 19A, 19B) and mode-locked (FIGS. 19C, 19D) frequency combs. Optical spectra (FIGS. 19A, 19C) and RF intensity noise spectra (FIGS. 19B, 19D).

FIG. 20 illustrates an evolution of on-chip optical power of the state-of-the-art electrically-pumped Kerr-frequency microcombsources, in accordance with aspects discussed herein. FIG. 20 labels each demonstration with the names of the main groups involved in each publication for the following references: Columbia3, EPFL/RQC4, UCSB/Caltech/EPFL5, UCSB/Caltech/Anello6, RQC/EPFL8, EPFL/UCSB9, RQC10.

FIGS. 21A-21B illustrate comb generation configuration with an additional low-Q ring in add-drop configuration. FIG. 21A provides a fabricated device, with the inset providing a zoomed in view of the add-drop ring and integrated heater. FIG. 21B provides a frequency comb spectrum.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

The present disclosure enables use a multimode gain chip as a pump source to drive a high-power broadband frequency comb by coupling it to a high-Q silicon nitride (SiN) ring resonator. As demonstrated in one study, single-mode feedback, caused by resonant reflections from a high-Q SiN ring can lock a multimode gain to a single transverse and single longitudinal lasing operation. Since multimode gain is not limited in width, it can be efficiently pumped by very high currents, producing several-watt levels of power. When the single-mode power output of the gain chip is sufficiently high, parametric gain in the ring crosses the self-oscillation threshold and a frequency comb is generated. The ring, therefore, serves two purposes: (i) providing single-mode feedback in order to force single-mode lasing, and (ii) generating a frequency comb excited by the single-mode output of the laser.

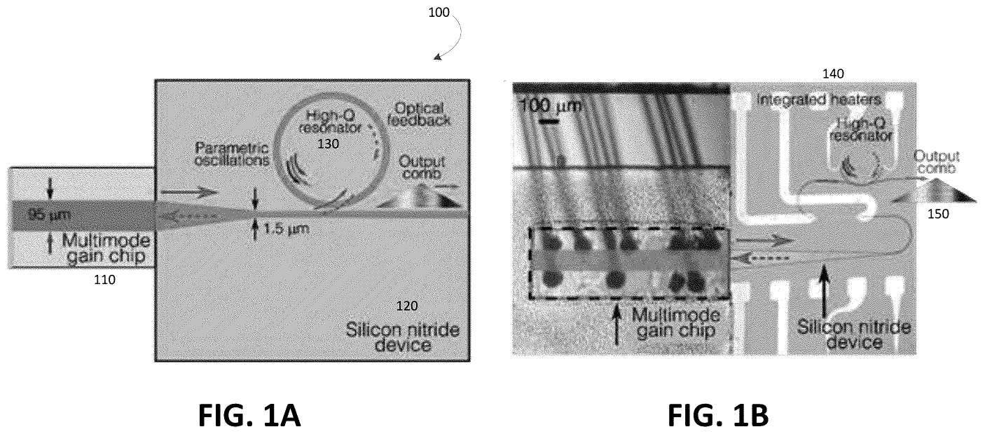

An integrated frequency comb source 100 can comprise a multimode gain chip 110 that is coupled with a SiN device 120. An example can be found in the schematic image in FIG. 1A and the optical image in FIG. 1B. FIG. 1A illustrates a multimode gain chip 110 coupled to a silicon nitride device 120. In an example, the multimode gain is 95 micrometers wide, and tapers town to 1.5 micrometers on the SiN device, where it is passed through a High-Q ring resonator 130. Optical feedback and the parametric oscillations generate an output comb 150, with the characteristics and qualities discussed herein. FIG. 1B illustrates an optical image of the multimode gain chip 110 and SiN device 120. FIG. 1B further illustrates at least one integrated heater 140 thermally connected to the ring resonator 130, configured to modulate the ring feedback, and allow for optional, continuous adjustment of the ring feedback to maintain the output frequency comb.

In various examples, the input coupler dimensions match those of the multimode gain chip. As seen in FIG. 1B, the length of the multimode gain chip can be 100 micrometers. In addition, the horn taper maximizes the coupling of the fundamental mode of the gain chip with that of the narrower waveguide of the bus waveguide and ring resonator (both with dimensions of 730 nm×1500 nm). The SiN ring resonators, for these dimensions, have anomalous group velocity dispersion, intrinsic Q-factors of the order of millions and reflect about 10-30% of the incoming light. The SiN device can further comprise integrated heaters, e.g., platinum heaters, in order to be able to tune the ring resonance and align the phase of the optical feedback, thus being able to perform self-injection locking without requiring significant changes of the gain chip pumping current.

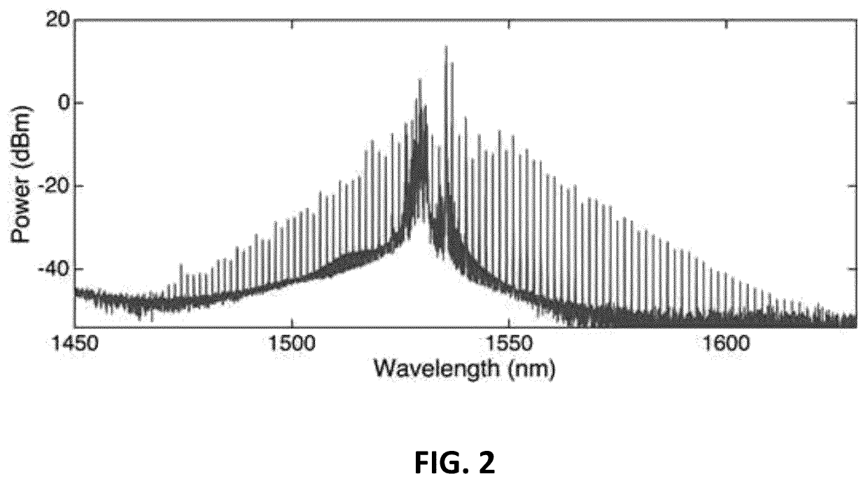

Accordingly, embodiments of the present disclosure can provide a broadband and high-power frequency comb generated in the device. FIG. 2 illustrates power (dBm) versus wavelength (nm) for a frequency comb spectrum, in accordance with embodiments. It should be appreciated that in FIG. 2, the optical spectrum of the frequency comb can span a bandwidth of ˜150 nm and the pump, at the output waveguide of the device, has an optical power of ˜23 mW.

Comb generation and self-injection locking requires careful tuning of a ring resonance with one longitudinal lasing mode. Embodiments can achieve this by slightly varying the pump current, which allows comb generation at less than full power. Embodiments can be adapted to optionally allow usage of the integrated platinum heaters, which can enable finer tuning and locking at the much higher pump currents. Moreover, it appears that spectral components in the middle of the comb spectrum, which do not match with the ring Free Spectral Range (FSR), e.g., ˜200 GHz, correspond to residual modes that have not been fully collapsed. However, these modes do not contribute significantly to the total power of the frequency comb.

In addition, it will be appreciated that similar combs can be generated with different multimode gain chips, such as commercially available, chips, and with different coupling conditions between gain and SiN device. In some examples, like in FIG. 2, the device insertion loss of the spectrum is ˜7 dB, and accounts for the coupling loss between gain and SiN and the extinction of the ring resonance.

Accordingly, results show a scalable approach to broadband high power frequency combs. The multimode gain has been shown to efficiently pump a single-mode microcavity, provided that the ring induces sufficient single-mode feedback. In turn, when the single-mode output of the laser crosses the threshold required for self-oscillations, the ring can produce a frequency comb, which can be as wide as 150 nm in some examples. Further optimization of the ring tuning mechanism would allow for self-injection locking and comb generation at higher current, thus unlocking the full potential of the multimode gain. This is a promising approach for achieving mass-producible frequency comb generators, while maintaining the key metrics required for industry driven applications.

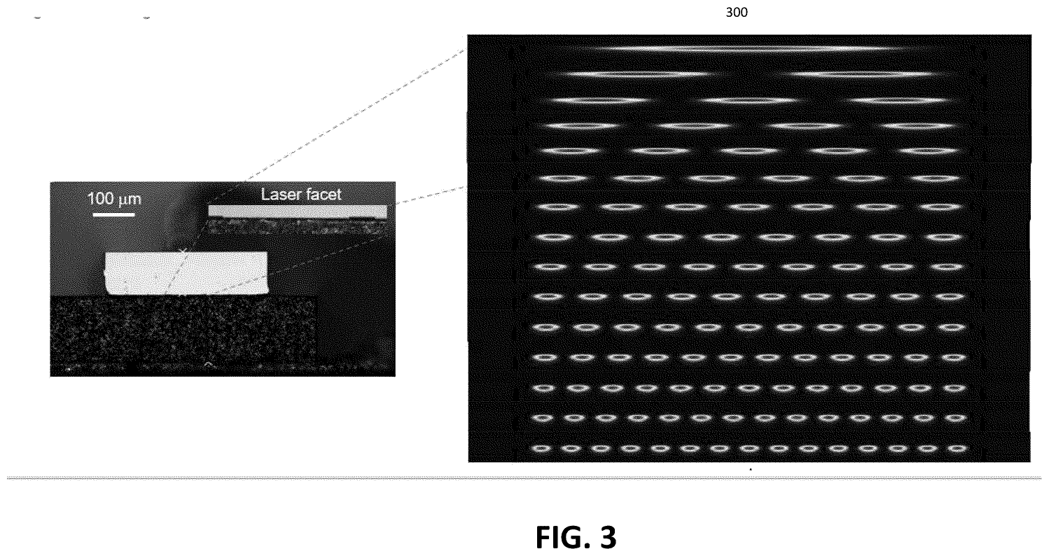

FIG. 3 illustrates an example of a series of modes 300 generated by multimode gain chips. In various examples, gain chips can have several modes. For a multimode gain chip with a size of approximately 100 micrometers, there can be hundreds of modes. In examples, 27 lines can be generated, with power greater than 100 μW, and 41 lines above 50 μW can be generated, with a laser pump current of 3 A. Embodiments also demonstrate a fundamental Lorentzian of 4 kHz width, and technical noise contribution of a Gaussian with 744 kHz for one of the comb lines. The linewidth of individual comb lines can be characterized by beating them with a reference laser and fitting the measured RF spectrum to a Voigt profile.

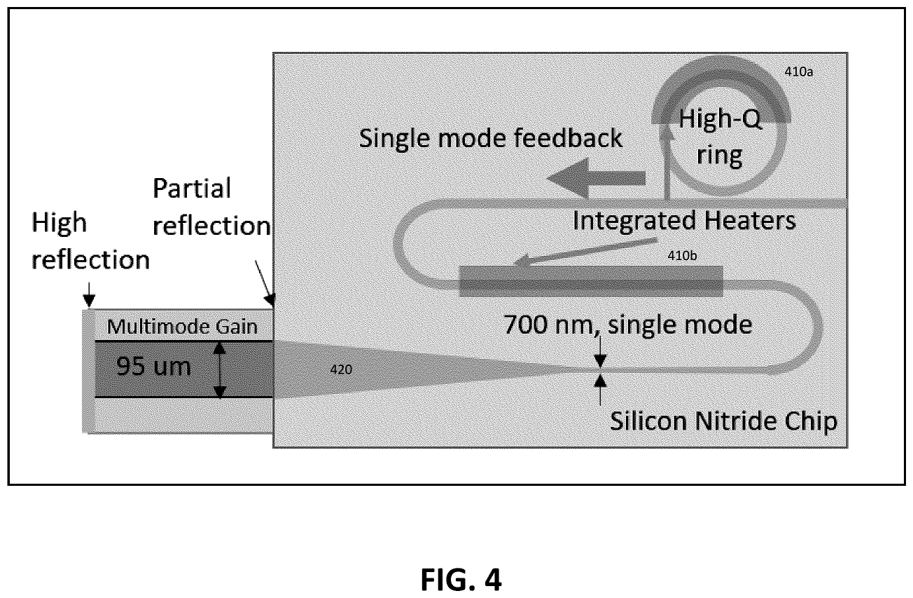

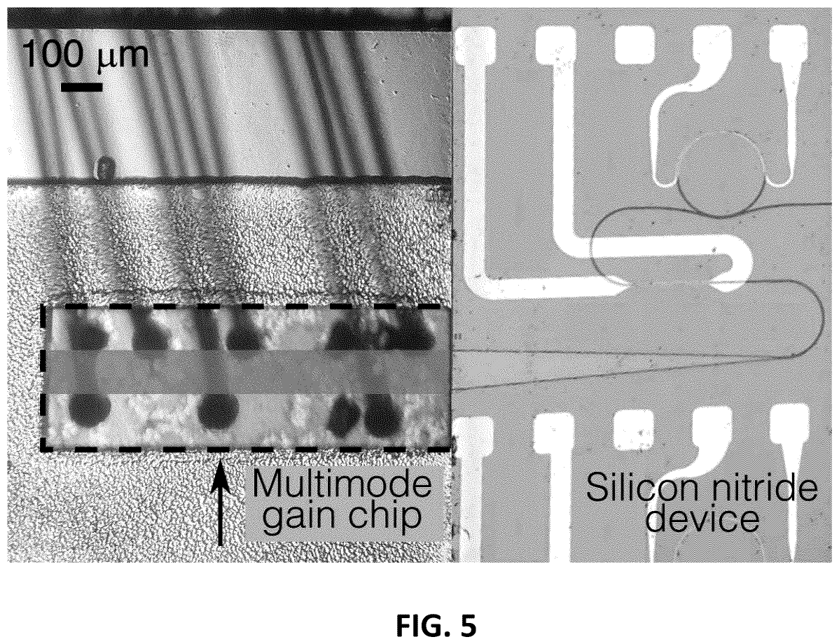

FIG. 4 illustrates another schematic detailing mode and frequency selective feedback, and FIG. 5 illustrates another view of the multimode gain chip coupled to a silicon nitride device. In the illustrated devices, a high-power multimode gain with a 95-micrometer width comprises high and partial reflections on its facets, forming a Fabry-Perot cavity. Adiabatic tapers 420 can taper down to 700 nm in some examples. The tapers assist in ensuring that feedback is provided only for the fundamental mode.

The high-Q ring resonator can provide frequency selective single mode feedback, due to resonant Rayleigh scattering. In some examples, it is estimated that it can reflect 10-20% of the light. In addition, integrated heaters 410a, 410b can be placed at various positions on the device to control the phase and tune the ring modes. Integrated heaters can be provided on the High-Q ring, which can provide single mode feedback, as well as one or more paths along the device, as noted by integrated heater 410b. In examples, these can be added to ensure that the ring provides the frequency selective feedback to one of the Fabry-Perot longitudinal nodes.

The principle behind the Fabry-Perot longitudinal mode selection comprises self-injection locking and mode competition for gain. This can occur when the light source, such as a laser, or more specifically, a Fabry-Perot laser, is locked by optical feedback that is built up in the resonator. Accordingly, by tuning one of the ring modes to match one of the Fabry-Perot longitudinal modes, mode collapse can occur. As such, a stable, single-emission frequency laser, with a narrow linewidth and high power can be obtained, and the emission considered “locked.” These effects have been observed, both theoretically and experimentally, in glass microresonators, for example, and integrated frequency comb sources.

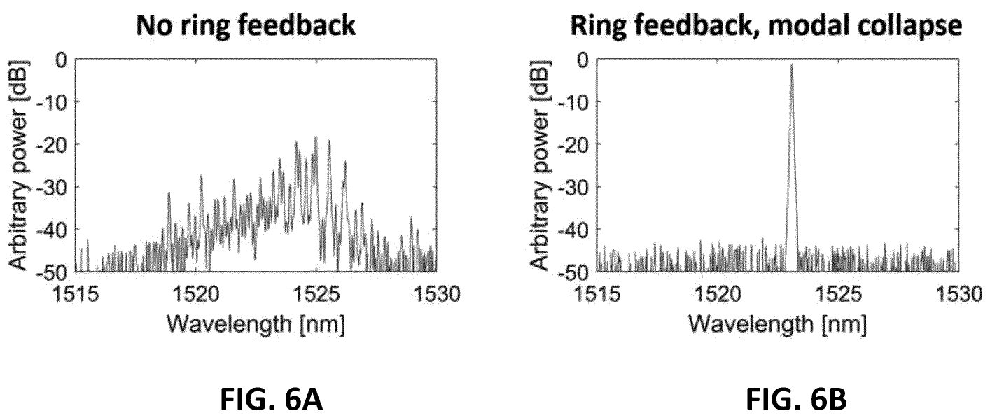

FIGS. 6A-6B illustrate spectral data for the frequency combs with no ring feedback, and ring feedback/modal collapse, respectively. The graphs illustrate that by tuning the ring mode and matching it with one of the Fabry-Perot longitudinal modes, modal collapse can occur. FIG. 6A shows that without ring feedback, the spectrum is significantly noisier than FIG. 6B, which evidences a peak around a 1523 nm wavelength. In other words, FIG. 6B demonstrates a side-mode suppression ratio of about 50 dB with the locked laser, compared to the spectrum with no ring feedback.

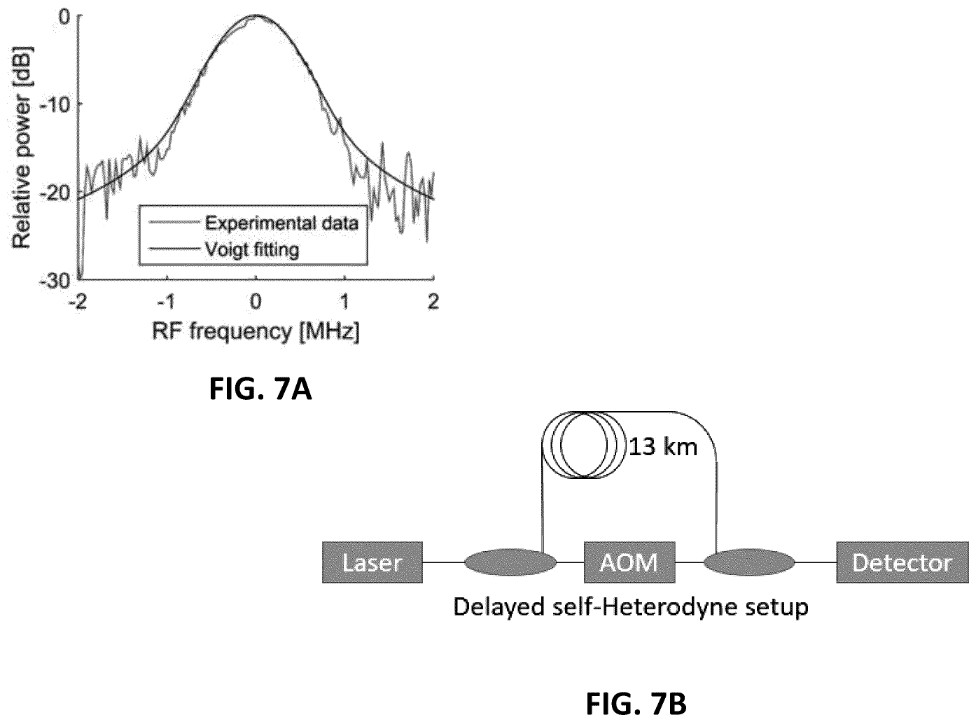

FIG. 7A illustrates linewidth for a locked laser configuration. The linewidth can be measured by performing self-heterodyning measurements. From this measurement, a Lorentzian linewidth is estimated to be 200 kHz with a technical noise contribution of the linewidth being 600 kHz. It will be appreciated however that this is not a fundamental limitation. The narrow line can also be tuned by having a mechanism for discrete tuning over a large spectral range as well a mechanism for fine tuning over a smaller spectral range.

FIG. 7B illustrates an example of a delayed self-heterodyne setup, in accordance with aspects of the present disclosure. The setup can comprise a laser connected to an acousto-optic modulator (AOM) and a detector, with a ring connection between the laser and AOM, and the AOM and the detector.

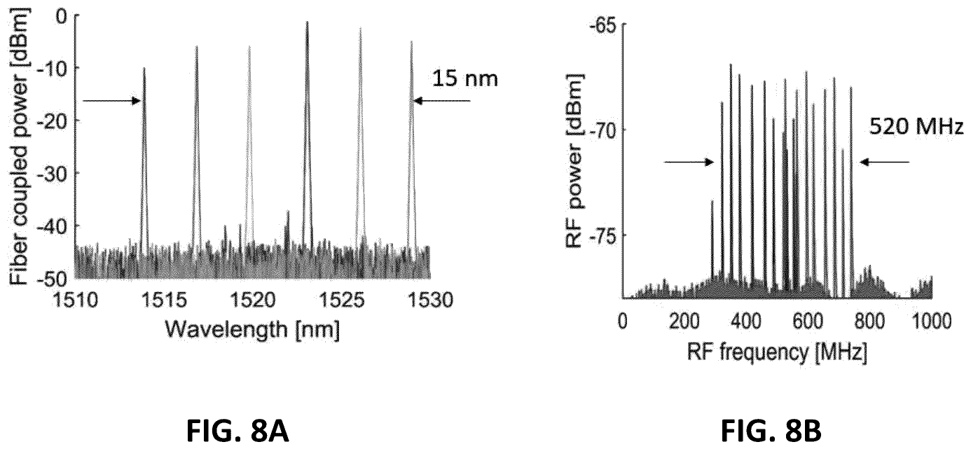

FIG. 8A-8B illustrates examples of wavelength tuning. To perform coarse tuning, both the ring modes and the phase in devices can be controlled. FIG. 8A illustrates how the ring modes and phases can be controlled to lock different longitudinal modes, e.g., Fabry-Perot longitudinal modes over the gain bandwidth. Accordingly, coarse tunability can be demonstrated for about 15 nm. FIG. 8B illustrates fine tuning, which can occur once one of the Fabry-Perot laser modes are locked. Fine tuning can comprise frequency pulling, wherein the locked laser follows the detuning of the ring mode. Such fine tuning can be performed by using the integrated heaters. As discussed herein, heterodyning measurements can be used to measure these effects, and show, for example, a fixed, stable narrow-linewidth reference laser at a wavelength close to that of the locked laser. FIG. 8B, for example, further shows a generated beat note tuned to around 500 MHz

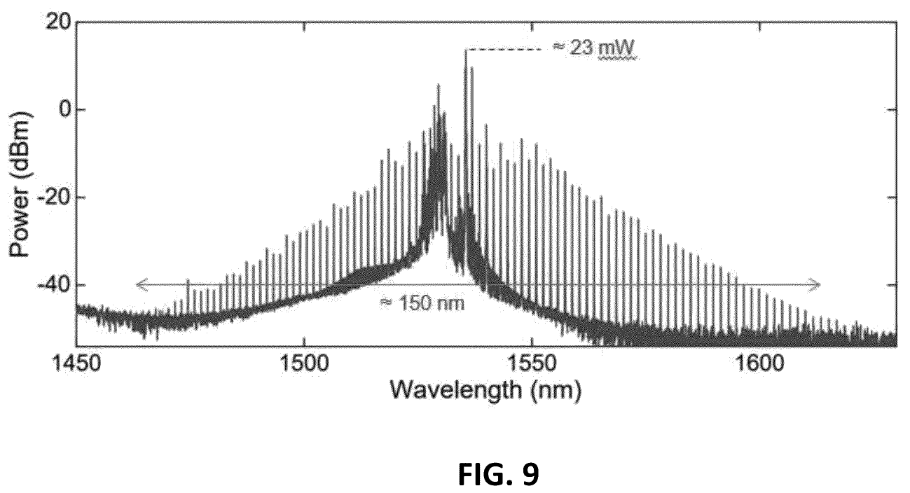

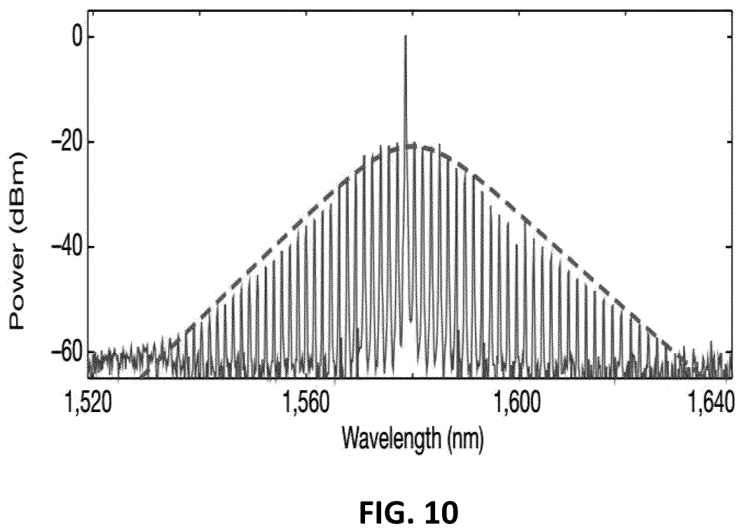

FIGS. 9-10 illustrate examples of high-power and broadband comb generation in accordance with aspects of the present disclosure. FIG. 9 illustrates power (dBm) versus wavelength (nm) for a comb spanning over 150 nm with 23 mW of power in the strongest line, which is approximately 125-1530 nm. FIG. 10 shows a similar example of high-power broadband comb generation, for a comb spanning over 120 nm with power in the strongest line around approximately 1575 nm. These results demonstrate that embodiments of the present invention can achieve high-power comb generation and has power scalability for integrated comb sources. Accordingly, embodiments can provide full transverse and longitudinal mode collapse, a narrow linewidth, laser tunability, and high-power broadband comb generation.

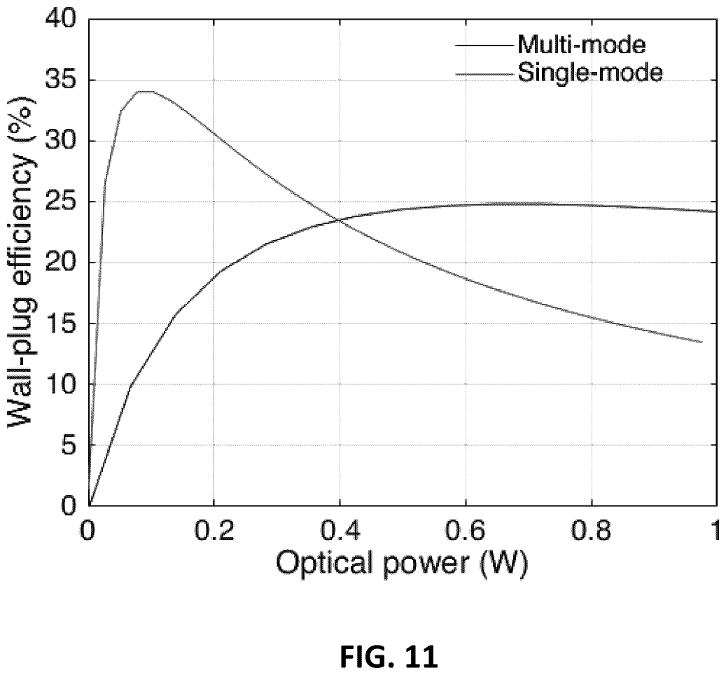

FIG. 11 optical power efficiency for multi-mode and single mode, in accordance with embodiments discussed herein. The graph illustrates that optical power is more efficient (30-35%) in the lower power range of less than 0.2 W. For multimode, efficiency increases as optical power increases, peaking at around 25% for powers greater than 0.4 W.

Accordingly, embodiments of the present technology uniquely describe techniques, methods, systems, and devices to generate high-power frequency combs in a silicon nitride ring resonator. As discussed herein, by using a multimode gain chip, power input into the silicon nitride ring resonator is greatly increased compared to a single mode gain chip. Single mode operation within the technology can be obtained by self-injection locking of the multimode gain using a high-quality factor micro resonator. The optical feedback from the ring into multimode gain chip forces high mode coherence in the transverse and longitudinal domains, allowing a high-power, single-mode source, to pump the ring resonator and producing a Kerr frequency comb. This technology also operates in the normal group velocity dispersion (GVD) domain, where the frequency spectra is relatively flatter than the anomalous GVD, making the technology an ideal reference source for telecommunication technologies. The technology can also be implemented in different material systems to produce frequency combs in other wavelengths as well.

This technology describes a technique to use a multimode gain chip to enable frequency combs with higher power outputs. The multimode to single-mode conversion within the device occurs by self-injection locking by using a high-quality factor ring resonator, while optical feedback from the ring forces mode coherence and converts the multimode into a single-mode source that can then be used to pump the resonator to produce a Kerr frequency comb. This technology can also be incorporated with different materials to allow frequency comb generation in different frequency regimes.

Various embodiments include a high-power comb generation in a silicon nitride (SiN) resonator operating the normal GVD regime using self-injection locking of a high-power multimode gain chip. As demonstrated, single mode gain chips are inherently limited in power handling and wall-plug efficiency when pumped with high current. This limitation can be addressed by utilizing highly multimode gain chips, with waveguides as wide as 100 μm. Single mode operation can be obtained by self-injection locking of the multimode gain by using a high-quality factor (Q) microresonator. Optical feedback from the ring back into the gain chip forces high coherence in both the transverse and longitudinal domains, yielding a high-power, single-mode source, which in turn pumps the nonlinear resonator, producing a Kerr frequency comb. It will be appreciated that embodiments are not limited to silicon nitride, and other materials, including but not limited to AIN, GaAs, InP, SiO2, lithium niobate, and MgF2 could be used.

In various embodiments, integrated resonators can be pumped by high-power optical source. Single transverse-mode III-V chips can also be integrated with the ring resonator. The power of the single-mode gain is usually limited to few hundred mW given the gain compression due to nonlinearities. The electrical resistance is about 10 times larger to that of the multimode gain, which can reduce the electrical efficiency significantly. In some examples, microtoroids can be used, but it can be difficult to tune the wavelength, and they are unintegrated, sensitive to the environment, and could be optically bulky when converting the multimode gain to the microtoroid.

WDM Transmission via High-Power Fully-Integrated Kerr Frequency Combs

Various examples discussed herein demonstrate high-power, fully-integrated Kerr frequency combs by self-injection locking multimode gain chips with silicon-nitride resonators. Some examples demonstrate 25 comb lines>100 μW with 200 kHz linewidth, and OOK modulation at 12.5 Gb/s.

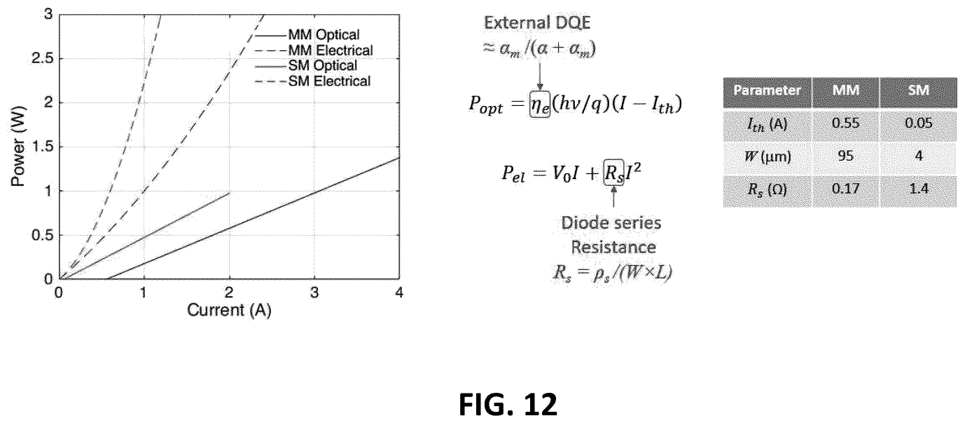

FIG. 12 illustrates multimode optical power, multimode electrical power, single mode optical power, and single mode electric power against current (A). Both multimode optical and multimode electrical show significant improvements and higher power capabilities than their respective single mode counterparts.

Integrated optical frequency combs have revolutionized several fields such as optical communications, spectroscopy, light detection and ranging, and time-keeping applications. However, despite important efforts in integrating III-V gain media with on-chip resonators, the demand for higher power and narrow linewidth is still present in most practical implementations of fully-integrated frequency comb sources. One clear example of such requirements is optical data communications, in which tens of lines are typically needed with power-per-line between 100 uW-mW and linewidth of MHz-scale comparable to that of distributed-feedback (DFB) lasers.

Various examples demonstrate high-power comb generation while obtaining narrow linewidth of the comb lines in a hybrid-integrated device. This approach leverages the high power provided by broad-area multimode laser diodes and the high pump-to-comb conversion efficiency of Kerr frequency combs that is achievable when using normal group-velocity dispersion (GVD) resonators. By self-injection locking in the nonlinear regime of the resonator, the low spectral and spatial coherence of the multimode laser can be purified, while achieving high-power locked Kerr combs.

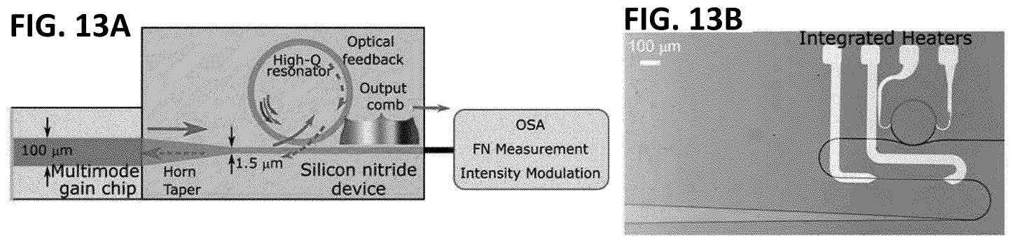

FIG. 13B shows a schematic of the hybrid-integrated device and the experimental setup used. A commercial multimode Fabry-Perot (FP) laser diode (optical power>1 W and wall-plug efficiency>25%) is coupled with a high quality factor (Q) silicon nitride resonator (QLoaded≈2×106). Minimal loss for the fundamental mode is ensured between the FP diode and nitride chip through adiabatic modal conversion through a ≈2 mm-long horn taper (width of 100 μm). In addition, examples demonstrate single-transverse mode and single-frequency feedback to the multimode FP laser via resonant Rayleigh scattering in the high-Q resonator (cross-section of 640 nm×1500 nm, radius of 115 μm, and FSR≈200 GHz). In order to perform resonance detuning and phase control of the laser feedback platinum-integrated heaters can be incorporated over the oxide cladding of the nitride chip. The spectrum at the chip output and the frequency noise of the comb lines can be monitored. External intensity modulation can also be performed via a 20-GHz electro-optic Mach-Zehnder modulator (MZM).

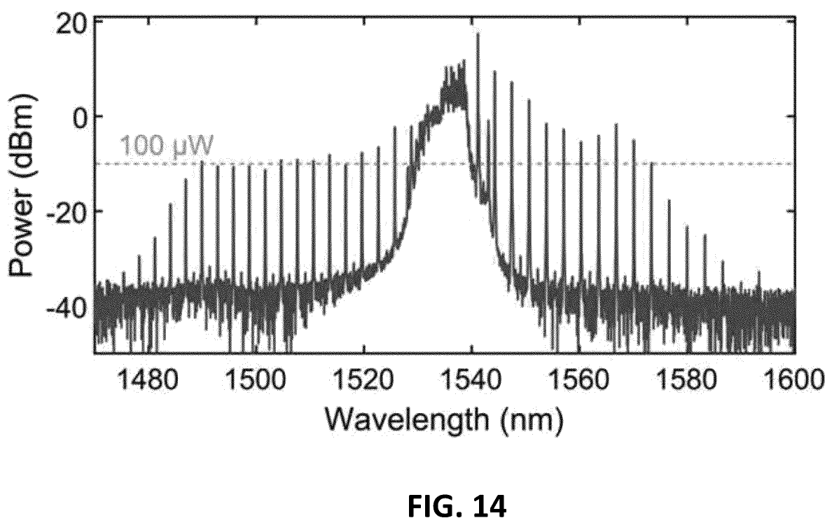

FIG. 14 shows a sample of the generated Kerr combs with spectral flatness observed in normal GVD resonators. This comb exhibits 25 lines>100 μW and the total power of the lines exceeding 80 mW (this is not taking into account the spectral shape in the middle of the spectrum, which is attributed to a limited modal-collapse in the multimode FP laser). The electrical power applied to the multimode FP laser was 2.76 W, leading to a wall-plug efficiency of the comb of 3%. By means of the integrated heaters, a locked comb state can be accessed, which has a frequency separation of 400 GHz, which corresponds to twice the ring FSR.

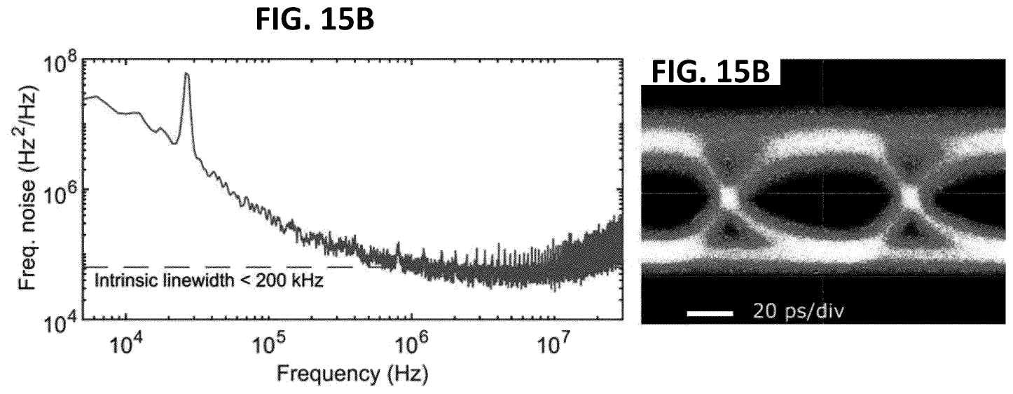

FIG. 15A shows the measured frequency noise of one of the lines around 1571 nm. An upper bound for the intrinsic linewidth of 200 kHz can be estimated from the flat region of the frequency noise between 106 Hz-107 Hz. This range is comparable with that of commercial external cavity lasers. The beat note from the measured time trace was further analyzed, and generated an estimated a Gaussian contribution to the linewidth of 650 kHz, which corresponds to the technical noise contribution. In addition, data modulation of one of the comb lines were demonstrated using an OOK signal at 12.5 Gb/s (FIG. 15B). The modulation rate is limited only by the pattern generator that is used. This implies that the demonstrated frequency comb source has great potential to be used as a multiple-wavelength source towards Tb/s transceiver technologies.

### References

[1] Gil-Molina A, Antman Y, Westreich O, Ji X, Gaeta AL, Lipson M. Fully Integrated Broad-Band High Power Frequency Comb Based on a Multimode Gain Chip. CLEO. 2021 May; pp. 1-2.
[2] Kondratiev N M, Lobanov V E, Cherenkov A V, Voloshin A S, Pavlov N G, Koptyaev S, Gorodetsky M L. Self-injection locking of a laser diode to a high-Q WGM microresonator. Optics Express. 2017 November; 25(23): pp. 28167-28178.
[3] A. L. Gaeta, M. Lipson, and T. J. Kippenberg, “Photonic-chip-based frequency combs,” Nat. Photonics 13(3), 158-169 (2019).
[4] A. S. Raja, A. S. Voloshin, H. Guo, S. E. Agafonova, J. Liu, A. S. Gorodnitskiy, M. Karpov, N. G. Pavlov, E. Lucas, R. R. Galiev, A. E. Shitikov, J. D. Jost, M. L. Gorodetsky, and T. J. Kippenberg, “Electrically Driven Ultra-Compact Photonic Integrated Soliton Microcomb,” Nat. Commun. 10, (2019).
[5] B. Stern, X. Ji, Y. Okawachi, A. L. Gaeta, and M. Lipson, “Battery-operated integrated frequency comb generator,” Nature (2018).
[6] Y. Antman, O. Westreich, A. Gil-Molina, X. Ji, A. L. Gaeta, and M. Lipson, “Slaving a Highly Multi-Mode Laser to an On-Chip Single Mode Microresonator,” in CLEO: Science and Innovations (Optical Society of America, 2020), pp. STu3O-4.
[7] A. L. Gaeta, M. Lipson, and T. J. Kippenberg, “Photonic-chip-based frequency combs,” Nat. Photonics 13(3), 158-169 (2019).
[8] B. Y. Kim, Y. Okawachi, J. K. Jang, M. Yu, X. Ji, Y. Zhao, C. Joshi, M. Lipson, and A. L. Gaeta, “Turn-key, high-efficiency Kerr comb source,” Opt. Lett. 44, 4475-4478 (2019).
[9] G. Lihachev, J. Liu, W. Weng, L. Chang, J. Guo, J. He, R. N. Wang, M. H. Anderson, J. E. Bowers, and T. J. Kippenberg, “Platicon microcomb generation using laser self-injection locking,” Nat. Commun. 13(1), 1-9 (2022).
[10] W. Jin, Q. F. Yang, L. Chang, B. Shen, H. Wang, M. A. Leal, L. Wu, M. Gao, A. Feshali, M. Paniccia, K. J. Vahala, and J. E. Bowers, “Hertz-linewidth semiconductor lasers using CMOS-ready ultra-high-Q microresonators,” Nat. Photonics 15(5), 346-353 (2021).
[11] A. Fülöp, M. Mazur, A. Lorences-Riesgo, Ó. B. Helgason, P. H. Wang, Y. Xuan, D. E. Leaird, M. Qi, P. A. Andrekson, A. M. Weiner, and V. Torres-Company, “High-order coherent communications using mode-locked dark-pulse Kerr combs from microresonators,” Nat. Commun. 9(1), 1-8 (2018).
[12] Y. Antman, A. Gil-Molina, O. Westreich, X. Ji, A. L. Gaeta, and M. Lipson, “High Power on-chip Integrated Laser,” arXiv preprint arXiv:2207.06279 (2022).

High-Power Electrically-Pumped Microcombs

Those skilled in the art also will readily appreciate that many additional modifications are possible in the exemplary embodiment without materially departing from the novel teachings and advantages of the invention. Accordingly, any such modifications are intended to be included within the scope of this invention as defined by the following exemplary claims.

Integrated microcombs are promising for numerous applications that require a small footprint, high output power, and high efficiency, such as data communications, sensing, and spectroscopy. Electrically-pumped microcombs have been recently demonstrated via hybrid integration of gain chips with high-quality-factor-integrated resonators. However, the overall optical power remains well below what is necessary for practical solutions. Various aspects demonstrate high-power electrically-pumped Kerr-frequency microcombs by integrating a low-coherence source with high output power and silicon nitride ring resonators. The resonators are designed with normal group velocity dispersion and leverage self-injection locking in the nonlinear regime for generating high on-chip power combs while, simultaneously, purifying the coherence of the pump source. Various embodiments show microcombs with total on-chip power levels up to 160 mW and comb lines with an intrinsic linewidth as narrow as 200 kHz. Such on-chip power levels are an order of magnitude higher than those reported in previous demonstrations. These novel electrically-pumped microcomb source has the size, power, and linewidth required for datacom, and can impact other areas such as high-performance computing, and ubiquitous devices for spectral-sensing and time-keeping applications.

The introduction of optical Kerr frequency combs into commercial markets has been hindered by the combs' low output power. Applications such as frequency-comb-based wavelength-division multiplexing (WDM), for example, demand high power, since state-of-the-art WDM systems already require tens of lines with power levels exceeding 100 μW to ensure large aggregated bandwidth and low bit-error rates. Today, microcomb sources integrated with electrically-pumped gain can consume extremely-low electrical power (98 mW3), but, accounting for all the usable comb lines (those above 100 μW), the on-chip total optical power obtained in these sources is less than 20 mW. Other recent works on Kerr combs with high-conversion efficiency from the pump have explored pump modulation17 or avoided-mode crossings in normal group velocity dispersion (GVD) resonators by using external high-coherence pumps. Although these frequency-comb demonstrations exhibit high on-chip total optical power levels (up to 110 mW), they suffer from an overall low wall-plug efficiency due to the use of high-coherence, non-integrated pumps.

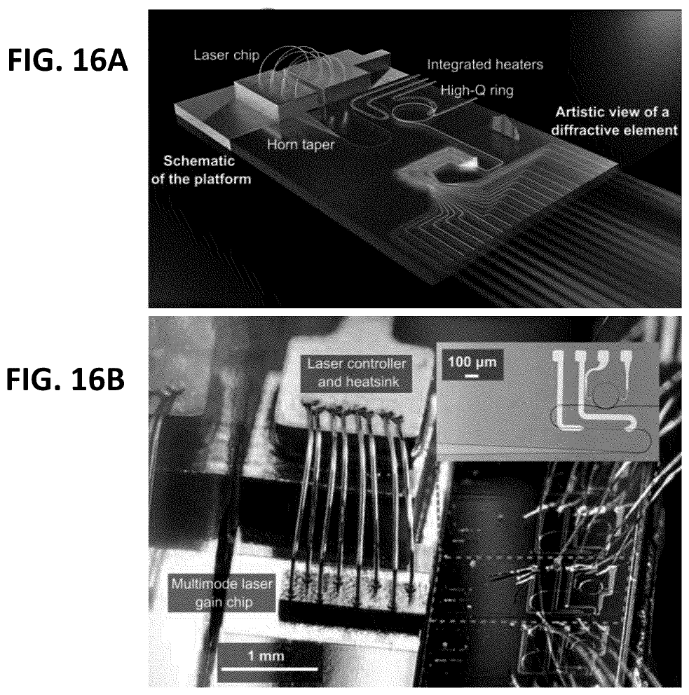

This shows that an electrically-pumped source with low-coherence (but typically Watt level power), in contrast to the high-coherence sources used to date, can generate locked Kerr-frequency combs with high power and narrow linewidth. To realize this, embodiments can leverage self-injection locking processes for the simultaneous a) generation of high-conversion efficiency combs in the normal GVD regime and b) spectral and spatial purification of the low-coherence source to provide sufficient pump power. Examples demonstrate hybrid integration of low-coherence III-V multimode lasers, with normal-GVD high-quality-factor (high-Q) silicon nitride (Si₃N₄) ring resonators as shown in the schematic of FIG. 16A. In order to ensure high power, various examples demonstrates off-the-shelf multimode laser with a wide emission area (95 μm×1 μm) allowing power levels up to a few W and low electrical consumption (wall-plug efficiency 30%). In order to ensure comb generation with high-conversion efficiency from the pump, examples leverage previously demonstrated self-injection-locking schemes in normal GVD resonators that differ from other techniques relying on pump modulation or avoided-mode crossings. By self-injection locking the low-coherent laser to the high-Q ring, examples can cause high spectral overlap between one lasing mode (longitudinal and transverse) and one of the ring resonances. With this high spectral overlap, the mode-locked comb states can be accessed and, at the same time, increase the coherence of the gain allowing sufficient buildup of power inside the resonator. In order to induce high-spectral coherence in the multimode laser, examples leverage resonant Rayleigh scattering in microrings with high-intrinsic Q˜3×10⁶ to provide spectrally-selective feedback In order to induce high-spatial coherence in the laser, Si₃N₄ chip can be used as an effective aperture for the laser feedback to benefit only one of the transverse modes35. Such embodiments minimize the loss for the fundamental TE mode by adiabatic modal conversion between the III-V and the Si₃N₄single-mode waveguide through a linear horn taper. Examples can ensure a robust power delivery to the Si₃N₄ chip by using a laser instead of a reflective semiconductor optical amplifier (RSOA). In addition, in order to ease the access to high-conversion efficiency coherent comb states, examples incorporate fine phase tuning in exemplary hybrid device via integrated platinum heaters in the Si₃N₄ chip. FIG. 16B shows a photograph of an exemplary hybrid device and that of a fabricated Si₃N₄ chip (see Methods for more details about the hybrid-integrated device).

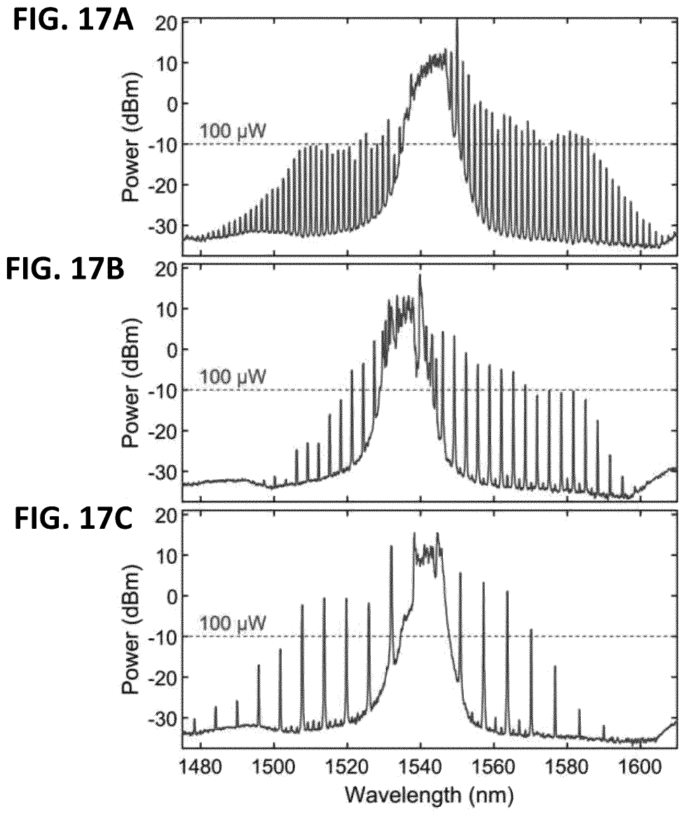

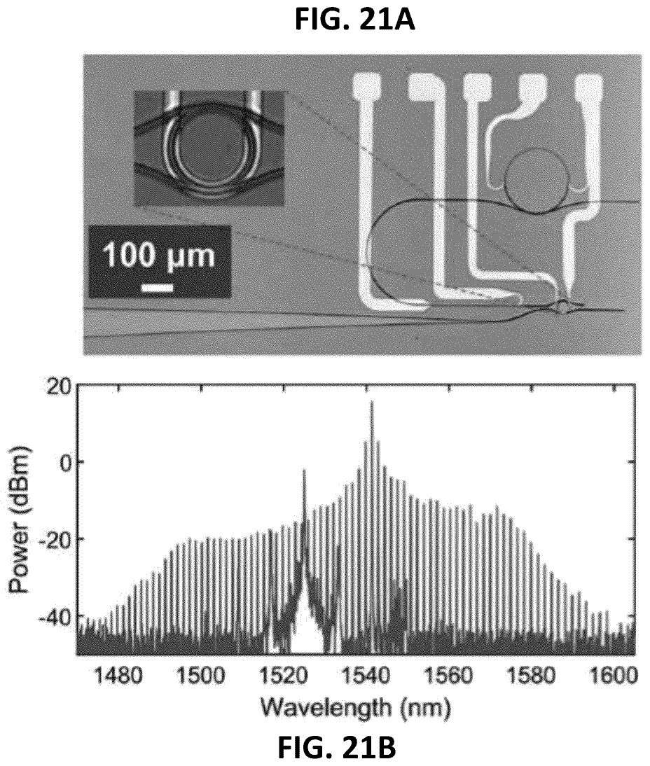

FIG. 17 shows different combs spectra with high on-chip power up to 160 mW, up to 27 lines above 100 μW, average power per line up to 3 mW, and comb separation ranging from 198 to 792 GHz. Embodiments generate these combs by tuning the phase in a device via the integrated heaters for different electrical pumping power of the gain. FIGS. 17B and 17C show that, for different applied electrical power to the pump laser and heaters (see Methods section for more details), embodiments generate combs with spectral separation larger than the ring FSR (i.e., 198 GHz), shown to be due to the formation of multi-pulse states with higher repetition rates. As the separation between lines increase, higher power per line can be achieved due to a higher conversion-efficiency from the pump, which represents a desirable combination for WDM communications. At the center of the spectra in FIG. 17A-17C, the spectral shape is dominated by amplified-spontaneous emission and low-gain spurious lasing modes that are not fully collapsed by self-injection locking. It has also been demonstrated that the mode collapse can be significantly improved by adding a low-Q ring (with a larger FSR) in an add-drop configuration between the laser and the high-Q ring (see FIG. 21), obtaining combs that are flat across the whole spectrum (see FIG. 21).

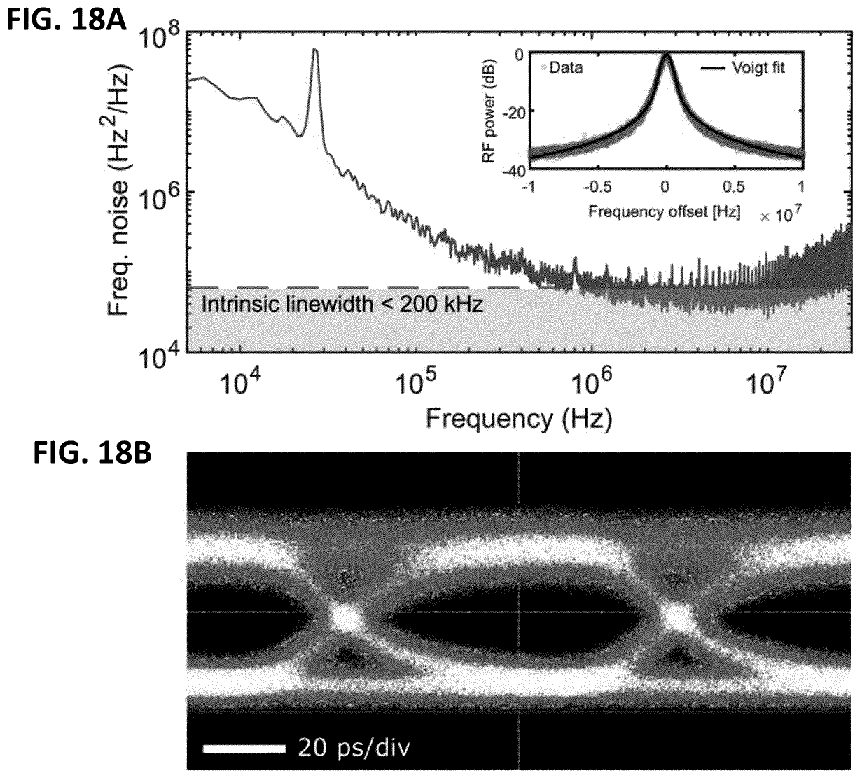

The intrinsic linewidth of the frequency comb lines can be narrower than 200 kHz, well below the linewidth needed for most applications. FIG. 18A shows the measured frequency noise with the upper bound of the intrinsic linewidth set above the flat region between 106 and 107 Hz. This was measured by a self-delayed heterodyne setup. In addition, the inset provides the measured beatnote lineshape along with a Voig profile fitted curve with an intrinsic (Lorentzian) contribution of 200 kHz and a Gaussian contribution of 650 kHz. The measured frequency noise and lineshape correspond to one of the lines of a locked-comb separated by twice the ring FSR at 1570.5 nm, however, intrinsic linewidths have been observed for the different kinds of combs ranging from 200 kHz to 1.5 MHz. The intrinsic linewidth obtained for the locked state is comparable to that of typical external-cavity lasers widely-used in long-haul and data-center communications. In order to further show the usability of the comb lines for datacom, FIG. 18B shows an open eye diagram at 12.5 Gb/s. This measurement uses the line of a comb separated by 4 times the ring FSR at 1570.3 nm (also with ˜200 kHz intrinsic linewidth) and a commercial electro-optic modulator.

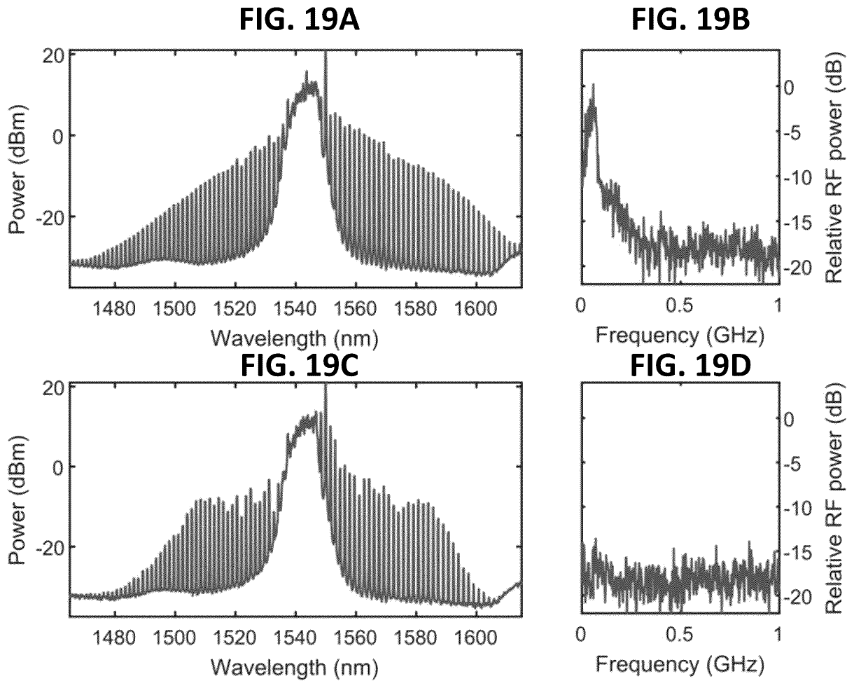

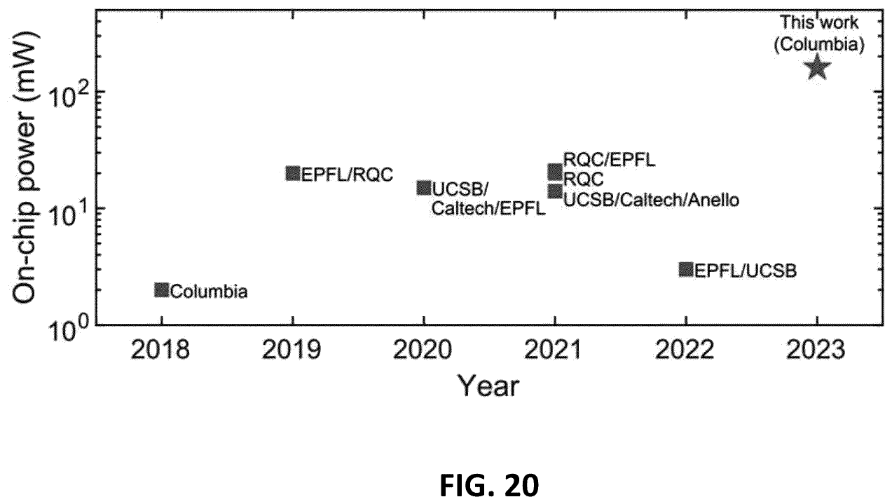

The mode-locked combs can also be identified by monitoring the comb radio-frequency (RF) intensity noise in various experiments. FIG. 19 compares two different combs, an unlocked-chaotic comb (FIGS. 19A and 19B) and a mode-locked one (FIGS. 19C and 19D). This measurement demonstrates a filtered portion of the comb from 1560 to 1580 nm before detection. Note the RF power reduction when transitioning from the unlocked comb to the mode-locked state.

This demonstration provides a clear path for scalability in optical power of Kerr-frequency combs sources. Such sources can revolutionize applications allowing, for example, a significant reduction of footprint, power consumption, and cost of WDM optical transceivers; the wide availability of remote devices for geolocalization, spectroscopy, and distance ranging; and the miniaturization of promising quantum technologies. FIG. 19 shows the chronological order of the evolution of on-chip power of the state-of-the-art electrically-pumped Kerr-frequency microcomb sources since the first demonstration in 2018. These results present about one order of magnitude increase in on-chip power. Considering the maturity of state-of-the-art pick-and-place tools and flip-chip bonding technologies, approaches could be compatible with wafer-scale fabrication, allowing mass production of high-power frequency comb sources.

Methods—Fabrication

Si₃N₄ devices can be fabricated with various processes. This can start by thermally-oxidizing a crystalline silicon wafer to form a 4 μm thick layer that acts as the bottom-waveguide cladding. A 640 nm thick film of Si₃N₄ can be deposited over the oxide layer by using low-pressure chemical vapor deposition (which can be performed to overcome film stress) and anneal the film after deposition. The devices are patterned using electron beam lithography followed by inductively-coupled plasma reactive-ion etching with Trifluoromethane (CHF₃), nitrogen (N₂), and oxygen (O₂) chemistry. In order to reduce waveguide sidewall roughness, a silicon oxide (SiO₂) hard-mask is applied with increased O₂ flow. In order to minimize the absorption due to N—H bonds, an extra annealing step can be performed in an Argon (Ar) atmosphere at 1200° C. A first thin layer of high temperature oxide (HTO) can be deposited for the top cladding (of around 3 μm of thickness), followed by a second thicker layer of SiO₂ by plasma enhanced chemical vapor deposition. Finally, a 100 nm thick layer of platinum can be sputtered and then the integrated heaters can be patterned by performing a lift-off process.

Hybridly-Integrated Device

The hybrid device can include of an off-the-shelf III-V multimode laser and a fabricated Si₃N₄ device. The multimode laser simultaneously provides high wall-plug efficiency and power even at high-injection current levels. Various examples demonstrate an output power of 1.4 W for the free-running laser for the maximum injection current of 4 A injection at 30% wall-plug efficiency. Note that the limit on the laser injection current of 4 A is due to the used laser driver, but the laser diode allows up to 6 A, providing a nominal output power of 2.5 W. The laser can be attached, or mounted in a C-mount, to a thermoelectric cooler (TEC) and heatsink. For most measurements, various examples can set the laser temperature between 23 and 25° C. and the power applied to the TEC no greater than 0.5 W. The low TEC power applied at such a high optical power is due to both the low thermal resistance and high wall-plug efficiency of the laser considering its wide gain area (95 μm of width by 1.5 mm of length). Both laser and Si₃N₄ chips can be edge-coupled by active alignment using three-axis stages for each chip. The stage used for the Si₃N₄ chip has piezo actuators that allow 20 nm resolution. The input horn taper facet of the Si₃N₄ chip can be polished to improve the coupling between the two chips and prevent damaging the front facet of the laser while the active alignment. The linear horn taper can have a length of 1.8 mm, an initial width of 95 μm, and a final width of 1.5 μm. In addition, any residual power of higher-order modes canbe filtered out by implementing a short section as narrow as 700 nm without adding additional loss to the fundamental mode. From eigenmode expansion calculations, it is estimated that around 80% of the power in the fundamental mode is transmitted through the taper. The waveguide of the resonator has a cross-section of 1500 nm×640 nm, which gives a normal GVD for wavelengths longer than 1480 nm. The intrinsic quality factor of the ring resonator was found to be around 3×10⁶. The resonator (which is close to the critical coupling condition) reflects between 10-20% of the power. An inverse taper for the output of the Si₃N₄ chip can be implemented, enabling collection of light through either a high numerical aperture aspheric lens or a lensed fiber of 2.5 μm mode-field diameter. The lens (or lensed fiber) can be aligned by using a three-axis stage with piezo actuators, similar to the one used for the Si₃N₄ chip. The Si₃N₄ chip can be placed on a metallic mount that, besides coupling, allows the integration with a printed-circuit board (PCB) used to supply electrical power to the integrated heaters through aluminum wire bonds. A data acquisition module (DAQ) can drive the heaters.

Comb Procedure and Measurement

In order to maximize the power of the coherent-comb states, various experiments adopted the following procedure: set a high Injection current (typically above 2 A, at which the free-running laser provides>700 mW) and TEC settings. For each Injection current value explored, coarsely align the chips and wait to achieve some thermal stability after a few minutes. The change in the laser temperature is due to the fact that a few percent of the light is being reflected back to the laser (tens of mW), which causes the TEC power to increase. Although comb generation is easily observed even without optimal coupling, once thermal stability is achieved, such examples perform a fine alignment with the piezo stages while maximizing the outputoptical power and monitoring the optical spectrum. While closing the gap between chips, there can be a high controllable variation of power (3 to 10 dB), which can be attributed to a coarse tuning of the feedback phase that allows the access to different self-injection locking regions. Once the chips have an optimal alignment, the integrated heaters can perform ring resonance detuning and fine adjustments of the feedback phase in order to access coherent-comb states. The electrical power applied to the heaters can be fine tuned and the coherence of one of the lines can be monitored using a self-delayed heterodyne setup. It is observed that by performing either red and blue detuning coherent-comb states can be accessed, in accordance to previous recent studies of electrically-pumped Kerr-frequency microcomb sources with anomalous and normal GVD resonators. Measurements are consistent and repeatable as long as all controllable parameters are similar (laser injection current, TEC parameters, ring and bus heater power levels applied).

Linewidth Measurement

Linewidth of the comb lines can be measured using a self-delayed heterodyne setup. One of the comb lines can be selected using a tunable optical band-pass filter. The insertion loss of the filter can be compensated by using an optical pre-amplifier (Erbium-doped fiber-based). The filtered line can be passed through a fiber-based Mach-Zehnder Interferometer (MZI). 500 m of single-mode fiber can be used as the path-length difference of the MZI and 100 MHz frequency shift between the arms by using an acousto-optic modulator. After the MZI, various examples can use a 2.1 GHz detector and a real-time oscilloscope to detect the signal. Observation of the lineshape of the comb line can be occur in real-time by performing a fast-Fourier transform (FFT) of the time-varying signal in the oscilloscope and post-process the data to calculate the single-sideband frequency noise.

References
1. Gaeta, A. L., Lipson, M. & Kippenberg, T. J. Photonic-chip-based frequency combs. Nat. Photonics 13, 158-169 (2019).
2. Kippenberg, T. J., Holzwarth, R. & Diddams, S. A. Microresonator-Based Optical Frequency Combs. Science 332, 555-559 (2011).
3. Stern, B., Ji, X., Okawachi, Y., Gaeta, A. L. & Lipson, M. Battery-operated integrated frequency comb generator. Nature 562, 401-405 (2018).
4. Raja, A. S. et al. Electrically pumped photonic integrated soliton microcomb. Nat. Commun. 10, 680 (2019).
5. Shen, B. et al. Integrated turnkey soliton microcombs. Nature 582, 365-369 (2020).
6. Jin, W. et al. Hertz-linewidth semiconductor lasers using CMOS-ready ultra-high-Q microresonators. Nat. Photonics 15, 346-353 (2021).
7. Briles, T. C. et al. Hybrid InP and SiN integration of an octave-spanning frequency comb. APL Photonics 6, 026102 (2021).
8. Voloshin, A. S. et al. Dynamics of soliton self-injection locking in optical microresonators. Nat. Commun. 12, 235 (2021).
9. Lihachev, G. et al. Platicon microcomb generation using laser self-injection locking. Nat. Commun. 13, 1771 (2022).
10. Dmitriev, N. Yu. et al. Hybrid Integrated Dual-Microcomb Source. Phys. Rev. Appl. 18, 034068 (2022).
11. Rizzo, A. et al. Integrated Kerr frequency comb-driven silicon photonic transmitter. ArXiv210910297 Phys. (2021).
12. Pfeifle, J. et al. Coherent terabit communications with microresonator Kerr frequency combs. Nat. Photonics 8, 375-380 (2014).
13. Marin-Palomo, P. et al. Microresonator-based solitons for massively parallel coherent optical communications. Nature 546, 274-279 (2017).
14. Shu, H. et al. Microcomb-driven silicon photonic systems. Nature 605, 457-463 (2022).
15. Fülöp, A. et al. High-order coherent communications using mode-locked dark-pulse Kerr combs from microresonators. Nat. Commun. 9, 1598 (2018).
16. Corcoran, B. et al. Ultra-dense optical data transmission over standard fibre with a single chip source. Nat. Commun. 11, 2568 (2020).
17. Lobanov, V. E., Lihachev, G. & Gorodetsky, M. L. Generation of platicons and frequency combs in optical microresonators with normal GVD by modulated pump. EPL Europhys. Lett. 112, 54008 (2015).
18. Kim, B. Y. et al. Turn-key, high-efficiency Kerr comb source. Opt. Lett. 44, 4475 (2019).
19. Xue, X. et al. Mode-locked dark pulse Kerr combs in normal-dispersion microresonators. Nat. Photonics 9, 594-600 (2015).
20. Xue, X. et al. Normal-dispersion microcombs enabled by controllable mode interactions. Laser Photonics Rev. 9, L23-L28 (2015).
21. Liu, Y. et al. Investigation of mode coupling in normal-dispersion silicon nitride microresonators for Kerr frequency comb generation. Optica 1, 137-144 (2014).
22. Jang, J. K. et al. Dynamics of mode-coupling-induced microresonator frequency combs in normal dispersion. Opt. Express 24, 28794-28803 (2016).
23. Yu, S.-P., Lucas, E., Zang, J. & Papp, S. B. A continuum of bright and dark-pulse states in a photonic-crystal resonator. Nat. Commun. 13, 3134 (2022).
24. Helgason, Ó. B. et al. Dissipative solitons in photonic molecules. Nat. Photonics 15, 305-310 (2021).
25. Partanen, H., Tervo, J. & Turunen, J. Spatial coherence of broad-area laser diodes. Appl. Opt. 52, 3221-3228 (2013).
26. Gapontsev, V. et al. High-efficiency 970-nm multimode pumps. in High-Power Diode Laser Technology and Applications III vol. 5711 42-51 (SPIE, 2005).
27. Liang, W. et al. Generation of a coherent near-infrared Kerr frequency comb in a monolithic microresonator with normal GVD. Opt. Lett. 39, 2920 (2014).
28. Gondarenko, A., Levy, J. S. & Lipson, M. High confinement micron-scale silicon nitride high Q ring resonator. Opt. Express 17, 11366-11370 (2009).
29. Luke, K., Dutt, A., Poitras, C. B. & Lipson, M. Overcoming Si₃N₄ film stress limitations for high quality factor ring resonators. Opt. Express 21, 22829-22833 (2013).
30. Ji, X. et al. Ultra-low-loss on-chip resonators with sub-milliwatt parametric oscillation threshold. Optica 4, 619 (2017).
31. Gorodetsky, M. L., Pryamikov, A. D. & Ilchenko, V. S. Rayleigh scattering in high-Q microspheres. J. Opt. Soc. Am. B 17, 1051 (2000).
32. Kippenberg, T. J., Spillane, S. M. & Vahala, K. J. Modal coupling in traveling-wave resonators. Opt. Lett. 27, 1669 (2002).
33. Kondratiev, N. M. et al. Self-injection locking of a laser diode to a high-Q WGM microresonator. Opt. Express 25, 28167 (2017).
34. Galiev, R. R. et al. Spectrum collapse, narrow linewidth, and Bogatov effect in diode lasers locked to high-Q optical microresonators. Opt. Express 26, 30509 (2018).
35. Antman, Y. et al. High Power on-chip Integrated Laser. (2022) doi:10.48550/arXiv.2207.06279.
36. Gil-Molina, A. et al. Robust Hybrid III-V/Si₃N₄ Laser with kHz-Linewidth and GHz-Pulling Range. in 2020 Conference on Lasers and Electro-Optics (CLEO) 1-2 (2020).
37. Corato-Zanarella, M. et al. Widely tunable and narrow-linewidth chip-scale lasers from near-ultraviolet to near-infrared wavelengths. Nat. Photonics 17, 157-164 (2023).
38. Cole, D. C., Lamb, E. S., Del'Haye, P., Diddams, S. A. & Papp, S. B. Soliton crystals in Kerr resonators. Nat. Photonics 11, 671-676 (2017).
39. Karpov, M. et al. Dynamics of soliton crystals in optical microresonators. Nat. Phys. 15, 1071-1077 (2019).

Embodiments

The following Embodiments are illustrative only and do not limit the scope of the present disclosure or the appended claims. Any part or parts of any one or more Embodiments can be combined with any part or parts of any one or more other Embodiments.

Embodiment 1. A method, comprising: receiving a multimode gain input on a device, wherein the device comprises a waveguide in optical communication with a ring resonator, and wherein the ring resonator is in thermal communication with a heater integrated with the device; determining a target mode by effecting, with the ring resonator, single-mode ring feedback; adjusting a temperature of the ring resonator so as to modulate the ring feedback, wherein the adjusting optionally comprises heating the ring with the heater; and applying the ring feedback to the multimode gain input to generate an output frequency comb that includes the target mode.

Embodiment 2. The method of Embodiment 1, wherein the multimode gain input is provided by a chip coupled to the device.

Embodiment 3. The method of any one of Embodiments 1-2, wherein applying the ring feedback to the multimode gain input effects self-injection locking.

Embodiment 4. The method of any one of Embodiments 1-3, wherein determining the target mode comprises self-injection locking to convert the multimode gain input to a single-mode channel.

Embodiment 5. The method of Embodiment 4, wherein the ring resonator is a high-Q ring resonator.

Embodiment 6. The method of any one of Embodiments 1-5, wherein applying the feedback at least partially collapses a mode of the multimode gain input.

Embodiment 7. The method of any one of Embodiments 1-6, wherein a laser source provides the multimode gain input.

Embodiment 8. The method of any one of Embodiments 1-7, further comprising generating a multimode gain within a Fabry-Perot cavity.

Embodiment 9. The method of any one of Embodiments 1-8, further comprising continuously adjusting the ring feedback application to the multimode gain input to maintain the output frequency comb that includes the target mode.

Embodiment 10. An integrated frequency comb system, comprising: a multimode gain chip configured to provide a multimode gain input; a device coupled to the multimode gain chip, the device comprising a waveguide and an integrated heater, the device configured to receive the multimode gain input; a ring resonator in optical communication with the waveguide and in thermal communication with the integrated heater, the ring resonator configured to effect a single-mode ring feedback to determine a target mode; the integrated heater adjusting a temperature of the ring resonator so as to modulate the ring feedback; and the ring resonator applying the ring feedback to the multimode gain input to generate an output frequency comb that includes the target mode.

Embodiment 11. The system of Embodiment 10, wherein the multimode gain chip has a cross-sectional dimension of around 100 micrometers.

Embodiment 12. The system of any one of Embodiments 10-11, wherein the multimode gain chip is a silicon nitride chip.

Embodiment 13. The system of any one of Embodiments 10-12, wherein the integrated heater continuously adjusts the ring feedback to the multimode gain input to maintain the output frequency comb that includes the target mode.

Embodiment 14. The system of any one of Embodiments 10-13, wherein the ring feedback at least partially collapses a mode of the multimode gain input.

Embodiment 15. The system of any one of Embodiments 10-14, wherein applying the ring feedback to the multimode gain input effects self-injection locking.

Embodiment 16. The system of any one of Embodiments 10-15, wherein the ring resonator is configured to determine the target mode using self-injection locking to convert the multimode gain input to a single-mode channel.

Embodiment 17. The system of any one of Embodiments 10-16, wherein the ring resonator is a high-Q ring resonator.

Embodiment 18. The system of any one of Embodiments 10-17, wherein a bandwidth of the output frequency combs spans approximately 150 nm.

Embodiment 19. A method, comprising operating a system according to any one of claims 10-18.

Embodiment 20. A method, comprising forming the system according to any one of claims 10-18.

What is claimed:

1. A method, comprising:
receiving a multimode gain input on a device, wherein the device comprises a waveguide in optical communication with a ring resonator, and wherein the ring resonator is in thermal communication with a heater integrated with the device;
determining a target mode by effecting, with the ring resonator, single-mode ring feedback;
adjusting a temperature of the ring resonator so as to modulate the ring feedback, wherein the adjusting optionally comprises heating the ring with the heater; and
applying the ring feedback to the multimode gain input to generate an output frequency comb that includes the target mode.

2. The method of claim 1, wherein the multimode gain input is provided by a chip coupled to the device.

3. The method of claim 1, wherein applying the ring feedback to the multimode gain input effects self-injection locking.

4. The method of claim 1, wherein determining the target mode comprises self-injection locking to convert the multimode gain input to a single-mode channel.

5. The method of claim 1, wherein the ring resonator is a high-Q ring resonator.

6. The method of claim 1, wherein applying the ring feedback at least partially collapses a mode of the multimode gain input.

7. The method of claim 1, wherein a laser source provides the multimode gain input.

8. The method of claim 1, further comprising generating a multimode gain within a Fabry-Perot cavity.

9. The method of claim 1, further comprising continuously adjusting the ring feedback application to the multimode gain input to maintain the output frequency comb that includes the target mode.

10. An integrated frequency comb system, comprising:
a multimode gain chip configured to provide a multimode gain input;
a device coupled to the multimode gain chip, the device comprising a waveguide and an integrated heater, the device configured to receive the multimode gain input;
a ring resonator in optical communication with the waveguide and in thermal communication with the integrated heater,
the ring resonator configured to effect a single-mode ring feedback to determine a target mode;
the integrated heater adjusting a temperature of the ring resonator so as to modulate the ring feedback; and
the ring resonator applying the ring feedback to the multimode gain input to generate an output frequency comb that includes the target mode.

11. The system of claim 10, wherein the multimode gain chip has a cross-sectional dimension of about 100 micrometers.

12. The system of claim 10, wherein the multimode gain chip is a silicon nitride chip.

13. The system of claim 10, wherein the integrated heater continuously adjusts the ring feedback to the multimode gain input to maintain the output frequency comb that includes the target mode.

14. The system of claim 10, wherein the ring feedback at least partially collapses a mode of the multimode gain input.

15. The system of claim 10, wherein applying the ring feedback to the multimode gain input effects self-injection locking.

16. The system of claim 10, wherein the ring resonator is configured to determine the target mode using self-injection locking to convert the multimode gain input to a single-mode channel.

17. The system of claim 10, wherein the ring resonator is a high-Q ring resonator.

18. The system of claim 10, wherein a bandwidth of the output frequency combs spans approximately 150 nm.

19. A method, comprising operating a system according to claim 10.

20. A method, comprising forming the system according to claim 10.
